(19) United States
(12) Patent Application Publication
(10) Pub. No.: US 2010/0329822 A1
(43) Pub. Date: Dec. 30, 2010

(54) METHOD FOR PRODUCING A MULTIPLE-SECTION PUBLICATION DOCUMENT

(75) Inventor: Bruce Gear, Kent (GB)

Correspondence Address: HOLLAND & HART, LLP, P.O BOX 8749, DENVER, CO, 80201, UNITED STATES, 303-295-8000, 303-295-8261, patentdocket@hollandhart.com

(73) Assignee: A & G Intellectual Property LLP, Kent (GB)

(21) Appl. No.: 12/863,350

(22) PCT Filed: Jan. 19, 2009
(86) PCT No.: PCT/GB09/00153

§ 371 Date: Jul. 16, 2010

(30) Foreign Application Priority Data
Jan. 17, 2008 (GB) 0800873.2

(51) Int. Cl. B42C 9/00

(52) U.S. Cl. 412/6; 412/33

(57) ABSTRACT

A method of producing a multiple-section publication document (476) in a high-volume industrial process is disclosed. The method comprises generating a customised section (248) of the multiple-section publication document (476), the customised section (248) including user-required content type information (232, 720) and geographical information (230, 706, 708), obtained from a received user-specified content request (213), and using the customised section (248) to control an operation of compiling the multiple-section publication document (476). The using step includes picking, from a store (260) of pre-printed sections (264), a user-defined compilation (272) of pre-printed sections having content types corresponding to the user-required content type information (232, 720), binding the compilation (272) of pre-printed sections (264) and the customised section (248) into a unitary publication document (472), and applying a delivery address (458) to the publication document (472) using the geographical information (230, 706, 708).

### FIELD OF THE INVENTION

The present invention relates to printed publications. In particular, but not exclusively, the invention relates to a method for producing a user-customised or personalised multiple-section publication document suitable for high-volume, industrial-scale production.

### BACKGROUND TO THE INVENTION

Printed publication documents such as magazines, serials, journals and periodicals are commonplace. Such publication documents are usually published on a weekly, monthly or other regular publication cycle.

To produce publication documents cost-effectively at the quality and quantity demanded by the marketplace, several different high-volume print technologies have been developed. For example, publication documents in the form of magazines are often produced by offset lithography, gravure printing or flexography.

To produce a publication document using these methods, the document to be produced is usually broken up into short sections. Each section is printed separately to produce a plurality of pre-printed sections, known as signatures. The document is then assembled using a collating or gathering machine, which picks each pre-printed section in turn from a store, collates the sections into the correct order, and stacks the sections ready for binding.

These high-volume print technologies are cost effective only when several thousand identical copies of a publication document must be printed because, before printing can take place, image carriers such as plates or cylinders must be manufactured at relatively high expense for the print process. Furthermore, the collating apparatus is often a large, complex and costly machine which is designed to run almost continuously and at high speed. Using one of these high-volume printing technologies therefore gives rise to a high cost per printed document when the number of identical documents to be printed is small, but a low cost per printed document when the number of documents to be printed is large. Consequently, if there is a requirement to print a large number of individual, non-identical documents, high-volume print technologies are rarely cost effective.

Other, low-volume printing technologies, known generally as digital print or digital press, do not require physical image carriers. This means that each copy of a publication document can be different. Currently, however, the cost and quality of digital printing techniques compares poorly with the high-volume processes described above for large print runs. Typically, the relatively high cost per printed document of a low-volume, digital printing technology does not depend on the number of documents to be printed. In other words, there is little or no economy of scale. Consequently, printing a large number of individual, non-identical documents using a low-volume printing technology is also not cost effective.

Often, a publication document will be available for purchase at retail outlets. Alternatively, or in addition, a publication document may be available by subscription, in which case each issue of the publication document is sent, by a postal service, to each subscriber shortly after it has been printed.

In many markets, a large number of publication documents covering a wealth of different subject areas are available. The content of a publication document is typically directed to a particular subject area, but this subject area can be broad or narrow in scope. This leads to a great deal of choice for the reader. For example, a reader having an interest in soccer could select a publication document in the form of a magazine with content relating to all types of sport, or a magazine with content relating only to soccer, or even a magazine with content relating only to one soccer team.

However, a reader often has interests in a number of different, possibly unrelated subject areas. In this case, the reader may need to purchase several different publication documents in order to obtain content relating to these different subject areas. This may be unsatisfactory if the reader does not wish to read a large amount of content or purchase several publication documents.

The reader could instead select a single magazine covering a range of topics, such as a general-interest or ‘lifestyle’ magazine. However, the content of such magazines is chosen by the publishers to reflect the interests of an average or target reader, with the undesirable consequence that some of an individual reader's interests may not be represented in the chosen magazine, whilst some content may be of little or no interest to the reader.

In addition to editorial content such as features, news articles and so on, magazines usually carry advertisements. The advertisements within a magazine are normally specifically chosen so as to be appropriate to an average or target reader of the magazine. For example, the advertisements may be directed to products or services that lie in the same subject area as the magazine, or in related subject areas, on the assumption that the reader will be receptive to such advertisements.

However, in practice, only a fraction of the readership of a magazine will actually be interested in any one advertisement. Consequently, a significant amount of advertising is essentially ignored as irrelevant or not of interest to a reader. This means that some of the advertiser's costs are wasted, the publisher's advertising revenue is suppressed, and the reader is exposed to advertising content of no interest to them.

Historically, attempts have been made to introduce an element of customisation into publication documents produced using high-volume print technologies.

For example, U.S. Pat. No. 3,917,252, the contents of which are incorporated herein by reference, describes a method for producing different versions of a publication document, made up of different pre-printed sections, for different groups of subscribers. A gathering machine is provided with a number of alternative pre-printed sections. For each different version of the document, a different set of pre-printed sections is produced. For example, different versions of a document could be produced for subscribers based in different geographical areas. However, this method is capable only of a relatively coarse degree of customisation.

European Patent Application Publication No. EP 0395131 A1, the contents of which are also incorporated herein by reference, describes a refinement of this method, utilising a collating machine that incorporates checkpoints to detect errors in the collation of the document. However, no improvement in the degree of customisation is disclosed.

U.S. Pat. No. 4,149,711, the contents of which are also incorporated herein by reference, describes a method for printing personalised information onto materials to be inserted into a magazine or similar publication. The method allows, for example, individually customised pre-printed subscription cards to be inserted within the pages of a magazine. The personalised materials are printed on-line, during the collating process. However, the publication itself is not customised.

U.S. Pat. No. 5,114,128, the contents of which are also incorporated herein by reference, describes an alternative approach, in which personalised sections are printed off-line and are collated along with non-personalised sections. Here, only the personalised sections are customised: the rest of the publication is not customised.

US Patent Application Publication No. US 2002/0040374 A1, the contents of which are incorporated herein by reference, describes a method of producing a publication document which is indicative of more recent efforts to address some of the problems outlined above. A personalised or customised publication document is produced for each individual subscriber to a magazine, so that the content of the publication document corresponds closely to the subscriber's interests.

In the method, the subscriber's content preferences are obtained, then content which corresponds to the preferences is selected from a content database. The content can also include advertisements which are selected based on the subscriber's indicated content preferences. The selected content is output to a high-speed digital printer, which prints pages of the publication document. The pages are then assembled into a finished publication document which is dispatched to the subscriber.

A similar method is described in US Patent Application Publication No. US 2006/0190125 A1, the contents of which are also incorporated herein by reference. In this case, the content preferences of a recipient are determined using various sources such as Internet tracking, survey information, buying patterns and so on.

Such methods offer the reader a choice of content, and allow advertisements to be directed in accordance with that choice of content. However, because each page must be individually printed for each subscriber or recipient, the speed of production of the publication documents can be slow and the cost of production can be high as described above. In addition, the quality of print can be compromised when using digital printing techniques, compared to high-volume print technologies such as offset lithography, gravure printing or flexography. For these reasons, it is often neither practical nor commercially feasible to use such a method for large-scale industrial publication operations.

Against this background, it would be desirable to provide a method for producing a customised or bespoke printed publication document which avoids or mitigates some of the above-mentioned problems.

### SUMMARY OF THE INVENTION

Accordingly, from a first aspect, the present invention provides a method of producing a multiple-section publication document in a high-volume industrial process, the method comprising generating a customised section of the multiple-section publication document, the customised section including user-required content type information and geographical information, obtained from a received user-specified content request, and using the customised section to control an operation of compiling the multiple-section publication document.

The using step includes picking, from a store of pre-printed sections, a user-defined compilation of pre-printed sections having content types corresponding to the user-required content type information, binding the compilation of pre-printed sections and the customised section into a unitary publication document, and applying a delivery address to the publication document using the geographical information.

Using this method, a customised multiple-section publication document, including pre-printed sections having content chosen by the user, can be produced. Because pre-printed sections are used for compilation into the multiple-section publication document, the majority of the publication document can advantageously be produced at relatively low cost and at high quality using existing high-volume print processes.

A bespoke customised section is also included in such a publication document. The customised section is advantageously used to control the operation of compiling the publication document, which means that the compilation of the publication document can be performed efficiently and accurately.

The customised section can include content comprising advertisements, images and text that has been personalised to the individual user. The customised section may be printed using a digital printing process, but because the customised section is a relatively small part of the publication document, the inclusion of the customised section does not significantly increase the cost of the publication.

The present invention therefore advantageously avoids the inefficiencies and costs associated with printing, using digital printing technology, an entire bespoke publication document individually for each user. However, the present invention still provides an entire publication document that is customised for an individual user. In other words, the present invention provides a method that combines digital printing technologies and high-volume printing technologies in an efficient and cost-effective way.

Each pre-printed section may comprise a machine-readable identifier for the content type of the pre-printed section, in which case the using step may further comprise reading the identifier of each pre-printed section in the compilation of pre-printed sections to obtain an actual content profile of the compilation, comparing the actual content profile with the user-required content type information from the customised section, and, if the comparing step indicates that actual content profile differs from the user-required content type information, rejecting the compilation of pre-printed sections.

In this way, the compilation of pre-printed sections can be checked to ensure that the correct pre-printed sections have been picked in accordance with the user's requirements. If the pre-printed sections have been compiled incorrectly, the error is detected before the publication document is bound. Having detected an error, the compilation can be rejected before the binding step so as to avoid wasting the pre-printed sections or delivering an incorrectly-compiled publication to the user. The pre-printed sections can be re-used.

Optionally, the identifier of each pre-printed section provides a non-overlapping part of a composite compilation identifier. In this case, the reading step comprises reading the composite compilation identifier, and the method further comprises decomposing the read composite compilation identifier into each of the individual pre-printed section identifiers.

Providing a composite compilation identifier has the advantage of allowing the identifiers to be read quickly, in particular when the reading step comprises optically reading the composite compilation identifier and the compilation is moving while the reading step takes place.

A relative positioning of each of the pre-printed identifiers in relation to a reference indicator may indicate a value of the identifier. For example, the compilation may be a stack of folded pre-printed sections of the publication document, and the pre-printed identifiers may each comprise marks on a spine portion of each pre-printed section. In this case, the reading step may comprise determining, using an electronic sensor, the relative position of a mark with respect to a reference indicator provided on the spine portion.

A plurality of versions of the identifier may be provided on the pre-printed section, and at least one version may be readable without distortion when the compilation is moving along a given direction. Similarly, a plurality of versions of the identifier may be provided on the pre-printed section, and the reading step may comprise reading at least two versions of the same identifier and the method further comprises correlating together the at least two versions of the same identifier to corroborate a read value of that identifier. Such arrangements allow the values of the identifiers to be accurately determined without errors, for example when the compilation is moving and/or when the compilation is angularly displaced or cocked.

The method may further comprise embedding the user-required content type information in a machine-readable tag, in which case the using step further comprises reading the tag to extract the user-required content type information. Alternatively, or in addition, the geographical information is embedded in a or the machine-readable tag and the using step further comprises reading the tag to extract the geographical information.

When the geographical information and user-required content type information are both to be embedded in a machine-readable tag, the method may comprise embedding geographical information in a first part of the machine-readable tag, and embedding the user-required content type information in a second part of the machine-readable tag.

By providing a machine-readable tag, the information for controlling the using step can be readily transferred to apparatus involved in the using step. Thus, the tag provides a convenient means to facilitate use of the information provided by the user to control the process of producing the publication document. Advantageously, the customised section comprises the machine-readable tag.

In one embodiment, a relative positioning of each of a plurality of indicia in relation to a reference indicator indicates a value of the user-required content type information in the tag. Furthermore, a plurality of versions of the indicia may be provided on the tag such that at least one version is readable without distortion when the tag is moving along a given direction. Alternatively, a plurality of versions of the indicia may be provided on the tag and the reading step may comprise reading at least two versions of the same indicium. In this case, the method further comprises correlating together the at least two versions of the same indicium to corroborate a read value of that indicium.

The user-required content type information may comprise one or more user-selected content categories. In this case, the method may further comprise allocating one or more different pre-printed sections to a plurality of user-selectable content categories. Two or more pre-printed sections from different content sources may be allocated to each user-selectable content category. The user-required content type information may instead comprise one or more user-selected content sources. In this way, the user-required content type information can be in a form suited to the nature of the publication document to be produced.

The generating step optionally comprises generating a customised section comprised of a cover section of the multiple-section publication document. Alternatively, the generating step may comprise generating a customised section comprised of an internal section of the multiple-section publication document. The generating step may comprise generating a customised section comprised of an index of each of the sections of the multiple-section publication document.

The method may comprise selecting one or more content items for inclusion in the customised section. In particular, the selecting step may comprise selecting at least one content item for inclusion in the customised section based on the user-required content type information, and/or selecting at least one content item for inclusion in the customised section based on the geographical information. The customised section can therefore advantageously be personalised to the user's specific content requirements, a profile of the user's preferences, and/or the user's geographical location.

The method may further comprise creating a content request including the user-required content type-information and the geographical information. The creating step can optionally be carried out remotely from the generating and using steps, in which case the method further comprises transmitting the remotely-created content request to a multiple-section publication document production location where the generating and using steps are carried out.

Advantageously, the creating step is implemented on a remote user computer or terminal and the transmitting step comprises transmitting the request over a wide-area communications network to the multiple-section publication document production location. Thus the creating step could for example be performed on a user's personal computer or mobile telephone and the request could be transmitted via the Internet.

In another embodiment, the method comprises storing information relating to a plurality of different users, the stored information including the content requests of a plurality of different users. Information relating to the stored content requests may be compiled to enable analysis regarding the associations between the different user-required content types selected by users, and the compiled information may be provided to a content generator for analysis. The compiling step may include correlating the associations between the different user-required content types selected by users and the geographical information.

The information relating to associations between the different user-required content types selected by users is particularly useful. For example, when the multiple-section publication is a magazine-style publication and the content types are magazine subject areas, this association-related information provides a new and valuable insight into which different, possibly diverse subject areas are of interest to a single user or reader.

The method may further comprise updating the store of pre-printed sections with new versions of the sections over a period of time, and repeating the generating and using steps to create an updated multiple-section publication document after all the sections corresponding to required content types of a content request being processed have been updated.

Advantageously, in another embodiment of the invention, the generating step comprises generating the customised section using bespoke digital printing techniques and each of the pre-printed sections has been printed using high-volume printing techniques.

According to a second aspect of the invention, a system for producing a multiple-section publication document in a high-volume industrial process is provided in which the system comprises obtaining means for obtaining user-required content type information and geographical information from a user from within a user-specified content request, generating means for generating a customised section of the multiple-section publication document based on the obtained information, a store of pre-printed sections, collating means for collating a user-defined compilation of different pre-printed sections, control means for controlling the operation of the collating means, the control means being arranged to use information from the customised section to control the operation of the collating means, binding means for binding the compilation of different pre-printed sections and the customised section into a unitary publication document, and addressing means for providing a delivery address to the publication document using the geographical information. Optionally, the system may further comprise checking means for checking the compilation of pre-printed sections.

Such a system may advantageously be arranged to implement the method of the first aspect of the invention.

According to a third aspect of invention, there is provided a system for producing a multiple-section publication document in a high-volume industrial process, the system comprising generating means for generating a customised section of the multiple-section publication document, the customised section including user-required content type information and geographical information, obtained from a received user-specified content request, and using means for using the customised section to control an operation of compiling the multiple-section publication document. The using means comprises picking means arranged to pick, from a store of pre-printed sections, a user-defined compilation of pre-printed sections having content types corresponding to the user-required content type information, binding means arranged to binding the compilation of pre-printed sections and the customised section into a unitary publication document, and addressing means arranged to apply a delivery address to the publication document using the geographical information.

The invention also extends, in a fourth aspect, to an electronic method of checking the contents of a compilation of a plurality of different pre-printed sections of a publication document with a user-specified content type information, wherein each pre-printed section of the compilation is provided with a machine-readable section indicium uniquely identifying the content of the section, and wherein the plurality of machine-readable section indicia comprise a composite indicium. The method comprises electronically reading the composite indicium to determine an actual content profile of the compilation, comparing the content profile with the user-specified content type information, and if the comparing step indicates that actual content profile differs from the user-required content type information, rejecting the compilation of pre-printed sections.

The method of the fourth aspect of the invention thus provides a convenient and accurate way of checking a compilation of pre-printed sections against a user's requirements, thereby avoiding unnecessary wastage and expense.

The method may further comprise decomposing the read composite indicium into a plurality of identifiers of the compiled sections, in which case the comparing step comprises comparing each of the plurality of identifiers with a correct compilation of identifiers as determined by the user-specified content type information.

The comparing step may further comprise comparing an order of the plurality of identifiers with an expected order of identifiers of a correct compilation as determined by the user-specified content type information. In this way, both the contents of the compilation and the order of those contents within the compilation can be verified.

The compilation may be a stack of folded sections of a publication document, and the section indicia each comprise marks on a spine portion of each section. In this case; the reading step may comprise determining, using an electronic sensor, the relative position of a mark with respect to a reference indicator provided on the spine portion.

Each section indicium may provide a non-overlapping part of the composite indicium.

A plurality of versions of a section indicium may be provided on each pre-printed section and at least one version is readable without distortion when the compilation is moving along a given direction. Similarly, a plurality of versions of an indicium may be provided on each pre-printed section, the reading step may comprise reading at least two versions of the same indicium, and the method may further comprise correlating together the at least two versions of the same indicium to corroborate a read value of that indicium.

When more than one version of a section indicium is provided, the content of each section is advantageously represented in more than one way to allow cross-checking or corroboration of the actual content profile of the compilation.

In a fifth aspect of the invention, an electronic checking apparatus is provided for checking the contents of a compilation of a plurality of different pre-printed sections of a publication document with a user-specified content type information, wherein on each pre-printed section of the compilation, a machine-readable section indicium uniquely identifying the content of the section is provided, and wherein the plurality of machine-readable section indicia comprise a composite indicium.

The apparatus comprises receiving means for receiving the user-specified content type information, reading means for electronically reading the composite indicium to determine an actual content profile of the compilation, comparing means for comparing the content profile with the user-required content type information, and rejecting means for rejecting the compilation of pre-printed sections if the comparing step indicates that actual content profile differs from the user-required content type information.

In a sixth aspect of the invention, there is provided a machine-readable image for storing an information value, the image comprising an indicium and first and second reference indicators, wherein a relative positioning of the indicium in a first orientation with respect to the first reference indicator and a relative positioning of the indicium in a second orientation with respect to the second reference indicator each independently represents the information value. Optionally, the indicium comprises a mark within the image.

By representing the information value in two independent ways, the stored information value can be retrieved accurately from the image when the image moves relative to a reading device in a direction corresponding to the first or second orientations, or in a direction angularly disposed to the first and second orientations. In particular, errors resulting from distortion or misregistration that arise due to the relative movement of the image can be avoided or eliminated by determining the information value using one or both of the independent representations.

The first reference indicator may comprise a reference line or points defining a reference line, in which case the first orientation may comprise a direction perpendicular to the first reference indicator.

Optionally, when the indicium comprises a mark within the image, the mark intersects the first reference indicator.

The second reference indicator may comprises a point within the image, and the second orientation may comprise a direction parallel to the reference line. The second reference indicator may intersect the first reference indicator.

Optionally, a thickness of the reference line indicates a further information value.

The image may comprise a plurality of indicia for storing a corresponding plurality of information values. In this case, a plurality of pairs of first and second reference indicators may be provided, each pair being associated with one of the plurality of indicia.

The image of the sixth aspect of the invention advantageously finds application in the optional machine-readable tag and/or in the optional machine-readable identifier for the content type of a pre-printed section in the first aspect of the invention, or as the machine-readable section indicium of the fourth or fifth aspects of the invention.

It will be appreciated that advantageous and/or optional features of each of the aspects of the invention may be incorporated into each of the other aspects of the invention also, alone or in appropriate combination.

### BRIEF DESCRIPTION OF THE DRAWINGS

Embodiments of the present invention will now be described, by way of example only, with reference to the accompanying drawings in which:

FIG. 1 is a flowchart showing steps in a method for producing a customised publication document in accordance with the invention;

FIG. 2 shows, schematically, apparatus suitable for performing the method of FIG. 1;

FIG. 3 shows, schematically and in greater detail, part of the apparatus of FIG. 2;

FIG. 4 is a flowchart showing steps in a process for obtaining information from a user as carried out by the apparatus of FIGS. 2 and 3;

FIGS. 5a to 5f show examples of web pages served by a web server of the apparatus shown in FIGS. 2 and 3, for use in the process of FIG. 4;

FIG. 6 shows an example of a confirmation e-mail generated by an e-mail server of the apparatus shown in FIGS. 2 and 3;

FIG. 7 shows, schematically, a database record generated by and stored in the apparatus shown in FIGS. 2 and 3;

FIG. 8 is a flowchart showing steps in a process for generating a stack of pre-printed sections based on information obtained from a user, which is implemented on the apparatus of FIGS. 2 and 3;

FIG. 9 shows a machine-readable tag containing information from the database record of FIG. 7;

FIG. 10 shows, schematically and in greater detail, a collating machine part of the apparatus of FIGS. 2 and 3;

FIG. 11 shows, schematically, a pre-printed section suitable for use in the method of FIG. 1;

FIG. 12 shows, schematically, the pre-printed sections of FIG. 11 arranged in a collated stack;

FIG. 13 shows, schematically and in more detail, a checking apparatus part of the apparatus shown in FIGS. 2 and 3; and

FIG. 14 shows, schematically and in more detail, a binding machine part of the apparatus shown in FIGS. 2 and 3.

### DETAILED DESCRIPTION OF PREFERRED EMBODIMENTS OF THE INVENTION

In one embodiment of the invention, a method of producing a customised or bespoke multiple-section publication document such as a magazine is provided. Each publication document includes a plurality of pre-printed sections, also known as signatures. Each pre-printed section can, for example, be an extract from or a specially-prepared short edition of a conventional (i.e. non-customised) magazine. In one preferred example, each pre-printed section comprises a compilation of sixteen pages taken from a commercially available magazine.

Each pre-printed section comprises pages bearing content relating to a particular subject area, known hereafter as the content type of the pre-printed section. In other words, the content type of a pre-printed section indicates the subject matter of the content of that section. Such content typically comprises text and/or imagery, and could include, for example, advertisements, articles, news features, listings and so on.

As will be explained in greater detail later, pre-printed sections having a large number of different content types are provided in a store of a publication document assembly apparatus, so that a pre-printed section with a given content type can be selected or picked from the store and included in a bespoke publication document.

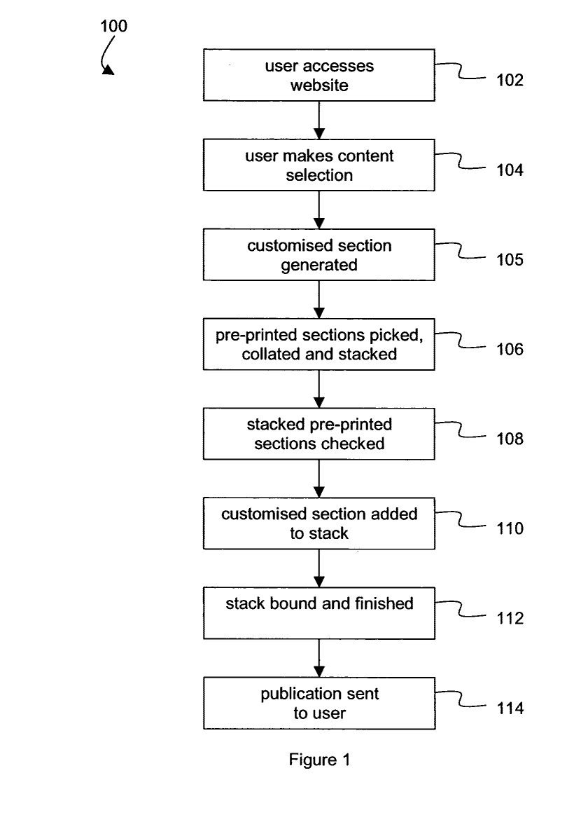

FIG. 1 shows, in overview, steps in the method 100 of producing a customised or bespoke publication document according to the present embodiment. To begin the process a reader or customer, known hereafter as a user, accesses, at step 102, an ordering website. As will be explained in more detail below, the website allows the user to make, at step 104, a selection of content types from a list of content types corresponding to the available content types of the pre-printed sections in the store. The selection of content types, and other information relating to an order for the bespoke multiple-section document, together form a user-defined content request.

A customised section for the publication is generated at step 105. The customised section carries the user-defined content request.

The customised section containing the content request is then used to pick, at step 106, a plurality of pre-printed sections, with content types corresponding to the selection of content types in the content request, from the store, collated and stacked in a suitable order.

The thus created stack of pre-printed sections is checked, at step 108, to ensure that the correct pre-printed sections, corresponding to the desired user selections, have been picked from the store.

The customised section is added, at step 110, to the stack. A cover is applied, at step 112, to the stack, and the stack is finished and bound.

Finally, the thus created publication document is sent, at step 114, to the user. In this way, the user receives a customised publication document which includes the specific content types selected by the user.

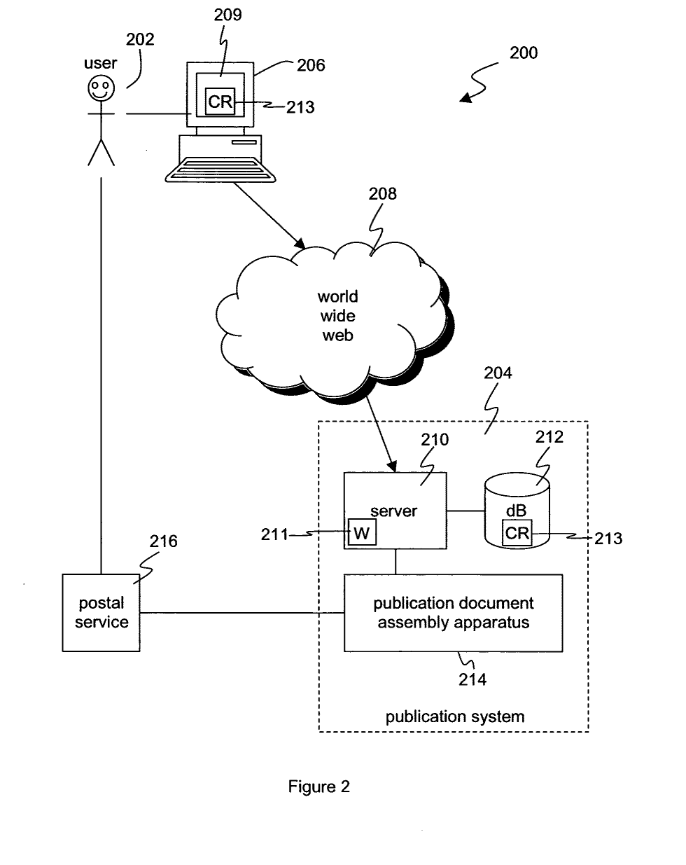

FIG. 2 shows, schematically, apparatus 200 suitable for performing the method shown in FIG. 1. A user 202 interacts with a publication system 204 via a user terminal 206 connected to the world wide web 208. Conveniently, the user terminal 206 is a personal computer with a browser 209 for accessing a website providing the bespoke print service.

The publication system 204 comprises a server 210 hosting a bespoke print service website 211 connected to a database 212 and a publication document assembly apparatus 214. The server 210 is also connected to the world wide web 208 for communication with the user terminal 206.

In use, the user 202 accesses a website served by the server 210 of the publication system 204 (see step 102 in FIG. 1), selects the content type required (step 104 in FIG. 1) and sends, via the user terminal 206, an individual content request 213 to the server 210 including the content types selected. As will be described in more detail later, the content request 213 includes information relating to the content type that the user requires, and geographical information, for example a postal address of the user for delivery of the created publication document to the user.

The server 210 receives the content request 213, and stores the content request 213 in the database 212. The server 210 then forwards the content request 213 to the production assembly apparatus 214.

The production assembly apparatus 214 uses the information in the content request to control an operation of compiling the publication document in accordance with the user's indicated requirements. Once the publication document's compilation and creation is complete, it is addressed using the geographical information in the content request, and output to a postal service 216 for delivery to the user 202.

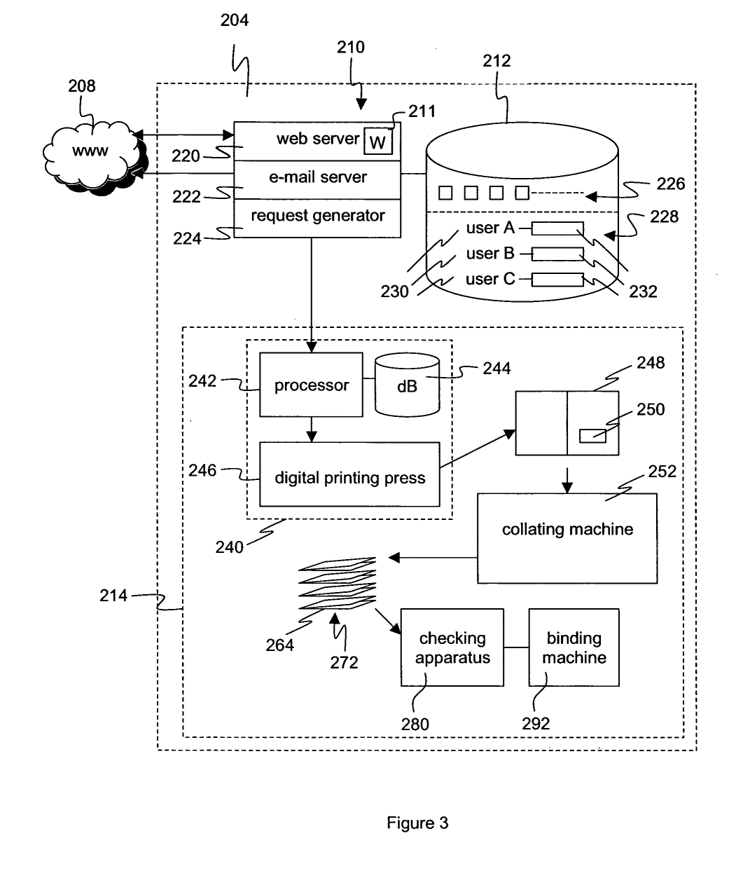

Each of the steps of the method shown in FIG. 1 will now be described in greater detail with particular reference to FIG. 3, which shows the publication system 204 in greater detail.

The server 210 comprises a web server 220, an e-mail server 222, and a request generator 224. The web server 220 and e-mail server 222 can communicate with to the user's terminal (not shown in FIG. 3) via the world wide web 208.

The web server 220 hosts a print service website 211 comprising a plurality of secure, user-accessible web pages, through which the user can place an order for a publication document. The database 212 stores these web pages, along with a list 226 of available content types. The database 212 also stores user information 228 in the form of a registration information record 230 for each user, and user-required content type information 232 associated with each user's registration information record 230. The user information 228 is populated using information submitted by a user via the web pages when the user places an order for a publication document.

The e-mail server 222 is configured to send a confirmation e-mail to the user via the world wide web 208 once the order has been successfully processed.

The request generator 224 formulates the content request 213 including the user-required content type information 232 and geographical information (such as a postal address) extracted from the registration information record 230. The content request 213 is transmitted to a customised section generator 240 of the production assembly apparatus 214.

The customised section generator 240 includes a processor 242 and associated database 244 configured to generate a customised section 248, bearing content determined by the information in the content request 213. The customised section 248 is printed by a digital printing press 246.

The customised section 248 includes a machine-readable tag 250 which includes information from the content request 213. In particular, the customised section 248 can include customised or personalised content (i.e. text and imagery), personalised advertisements and so on. As will be described in more detail below, the tag 250 provides instructions to control a collating machine 252.

The collating machine 252 selectively picks, from a store, a plurality of pre-printed sections 264 which correspond to the content type information 232 in the content request 213, and collates the pre-printed sections into a stack 272.

The collation or stack 272 of pre-printed sections is transported to a checking apparatus 280, which is configured to check that the correct pre-printed sections 264 are present in the stack 272.

After checking, the stack 272 is transported to a binding machine 292, which finishes and binds the pre-printed sections 264 and the customised section 248 to form a unitary publication document. The binding machine 292 can also add an address to the finished publication document according to the geographical information in the content request 213.

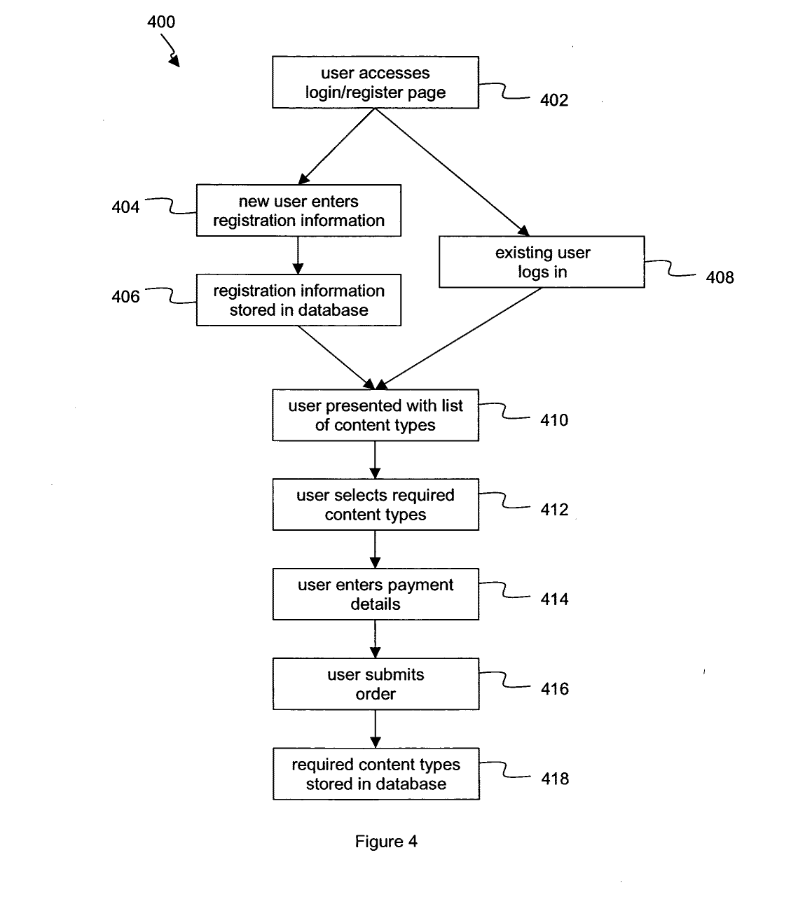

The process 400 of creating the registration information record 230 and user-required content type information 232 from users during the ordering process is shown in more detail in FIG. 4. Briefly, this process 400 starts with a user accessing, at step 402, a login/register page. If the user has not previously registered with the publisher, the new user enters, at step 404, registration information. The user's registration information is stored, at step 406, in the database 212 and the user is logged in. Alternatively, if the user has already registered, the existing user logs in at step 408.

Once logged in, the user is presented, at step 410, with a list of available content types. Non-limiting examples of content types for a magazine-style publication document include subject areas such as antiques, books, computers and games, DIY, travel, weddings, fashion, business, cricket, football, golf and so on. The available content types may relate to broad subject areas, such as sport, and/or narrow subject areas within the scope of the broader subject areas, such as motor sports, hockey and so on.

The user selects, at step 412, the content types required, and then enters, at step 414, payment details for the publication document. Once the user is satisfied with their order, the user submits or confirms at step 416 their order. The required content types, as selected by the user, are then stored, at step 418, in the database 212 as user-required content type information 232.

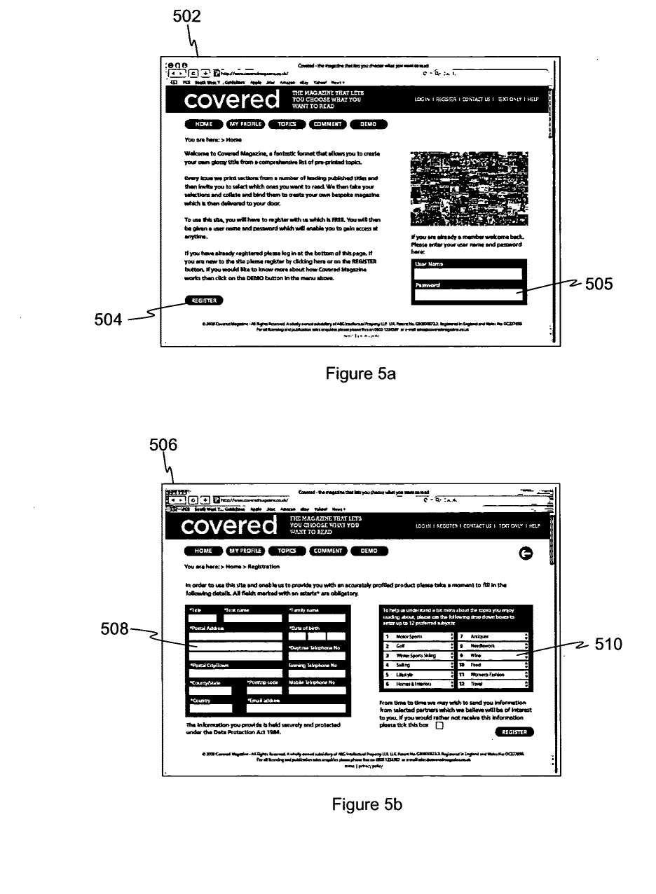

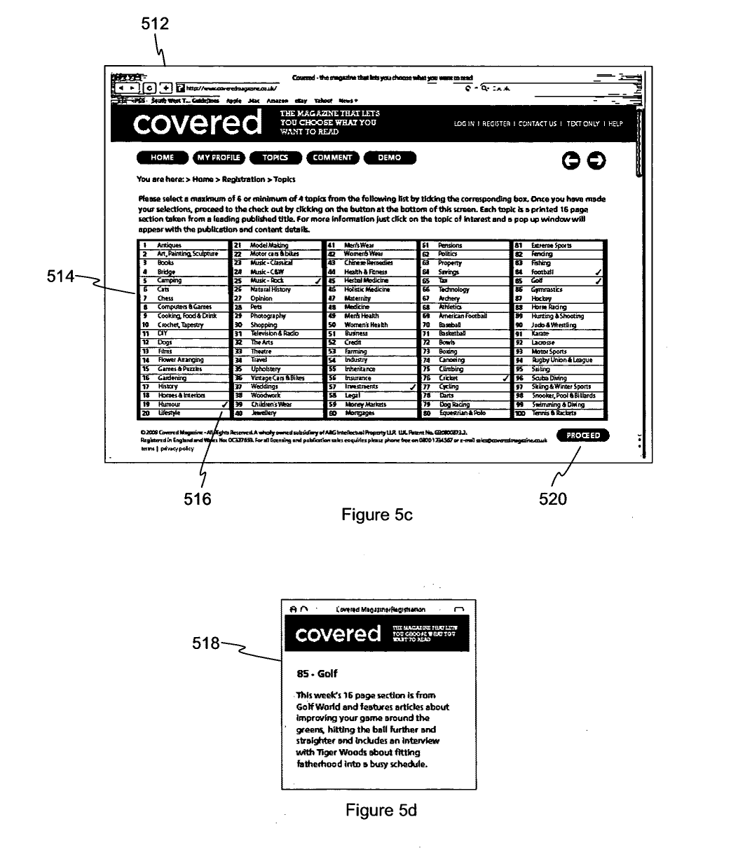

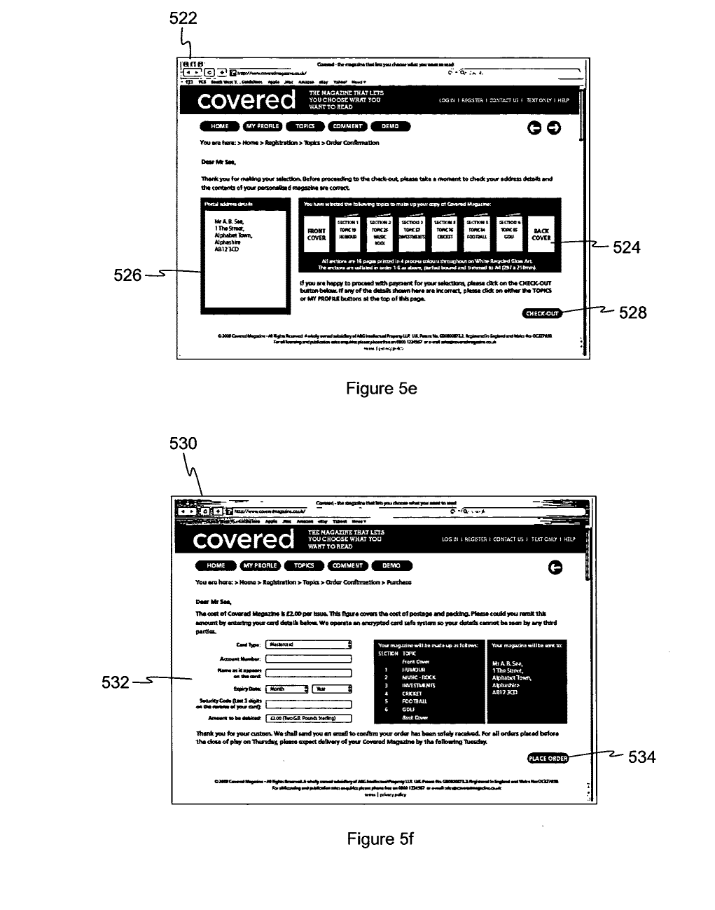

Each step in the ordering process will now be described in more detail, with reference to the examples of web pages suitable for use in the ordering process shown in FIGS. 5a to 5f.

First, the user accesses, at step 402 in FIG. 4, a home page 502 of the print service website 211, as shown in FIG. 5a, via a uniform resource locator (URL) provided by the publisher of the multiple-section publication document.

If the user has not previously registered their details with the publisher, the user is directed to click on a hyperlink 504 which directs the user to a registration page 506, shown in FIG. 5b.

The registration page 506 directs the user to enter, in a number of text fields 508, registration information (step 404 in FIG. 4). Typically, the registration information includes the user's real name and contact information such as a telephone number and e-mail address. The registration information also includes geographical information relating to the user, such as the user's postal address.

A unique user identifier (user ID) is allocated to the registration information by the web server 220. The user ID may be chosen by the user, or may be generated by the web server 220 and presented to the user. A password is also added to the registration information, and again the password may be chosen by the user or generated by the web server 220 and presented to the user.

The user may also be prompted to provide further optional information to be added to the registration information. For example, the titles of a number of subject areas may be presented to the user in the form of a drop-down list 510. The user can then indicate their subject area preferences by selecting those subject areas of most interest to them. Other demographic information, such as sex, age, household income, marital status and so on could also be requested.

The registration information record 230 for the newly-registered user is stored, at step 406 in FIG. 4, as part of the user information 228 in the database 212. A confirmation e-mail may be sent to the user, via the e-mail server 222, confirming that the registration process has been successful. For subsequent steps in the ordering process, the web server 220 associates the actions of the user with the stored registration information record 230 for that user.

If the user has previously registered their details with the publisher, the user can log in to the system (step 408 in FIG. 4). In this case, the user enters their user ID and password in appropriate text fields 505. The user ID and password are transmitted to the web server 220, where they are checked against the contents of the registration information record 230 stored in the database 212. If the user has correctly identified themselves by inputting a valid user ID and corresponding password, the web server 220 associates the actions of the user with the stored registration information record 230 for that user.

At step 410 in FIG. 4, the user is presented with a selection page 512, as shown in FIG. 5c. The selection page 512 comprises a list 514 of content types, and check boxes 516 for selecting a plurality of content types from the list 514. In the FIG. 5c example, 100 content types are included in the list 514.

As will be explained in more detail later, each of the content types in the list 514 corresponds to a pre-printed section available for inclusion in the publication document. In the example of a magazine-style document, each available pre-printed section comprises a ready-folded magazine signature containing content from, or in the style of, a commercially-available magazine. The pre-printed sections may be of any appropriate length, but in one application the sections are sixteen pages long.

The available content types 226 are stored in the database 212 so that the web server 220 can generate an appropriate list 514 in the selection page 512.

The user can click on an entry in the list 514 to cause a pop-up window 518 to appear, as shown in FIG. 5d. The pop-up window 518 presents additional information about the content type to the user. In particular, the source of the pre-printed section (for example, the magazine title from which the pre-printed section is sourced) associated with the selected content type can be displayed in the pop-up window or in the content type list 514.

After browsing the available content types, the user selects several required content types (step 412 in FIG. 4) from the list 514, for example by checking the appropriate check boxes 516. A minimum number of content types may need to be selected before the user can continue with the process. Similarly, the user may be restricted to selecting no more than a maximum number of content types. Once the user has made their selection, the user clicks a ‘proceed’ button 520 on the selection page 512 to submit the required content types to the web server 220.

The web server 220 then generates a selection confirmation page 522, as shown in FIG. 5e. The selection confirmation page 522 includes a visualisation 524 of the selected content types which are to make up the bespoke publication document, so that the user can confirm that the composition of the publication document corresponds to the required content types. In addition, the web server 220 retrieves the geographical information 526, i.e. the name and postal address, held in the registration information record 230 for the logged-in user. This information is also displayed for confirmation to the logged-in user.

The user confirms that the required content types displayed in the visualisation 524 are correct, and that the geographical information 526 is accurate, by clicking on a ‘check out’ button 528. This completes the content type selection step 412.

The web server then generates a payment page 530, as shown in FIG. 5f, which is presented to the user. The payment page 530 includes several payment information fields 532 for completion by the user. To perform step 414 in FIG. 4, the user enters payment information, such as credit card details, into the payment information fields 532 of the payment page 530. The payment information is sent securely in an encrypted format to the web server 220 when the user clicks a confirmation button 534 to submit the order for the publication document (step 416 in FIG. 4).

Of course, where the publication document is to be provided free of charge to the user, for example as part of a promotion or when the publication document is a catalogue or brochure, no payment step 414 will be required. In such a case, the web server 220 generates a confirmation page (not shown), which includes a confirmation button to allow the user to submit, at step 416, the order.

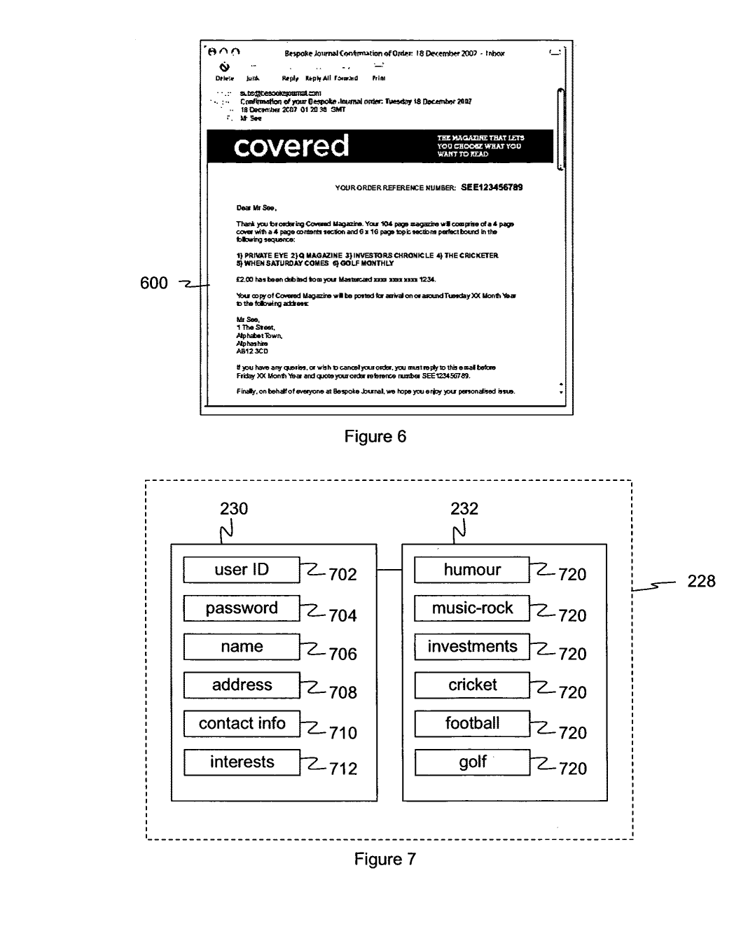

Once the order has been submitted, the web server 220 generates a confirmation page (not shown), which recites the details of the order and gives an estimated delivery date to the user. In addition, the e-mail server 222 generates a confirmation e-mail, which is sent to the e-mail address stored in the registration information record 230 of the user. An example confirmation e-mail 600 is shown in FIG. 6.

Once the user has confirmed the order to complete step 416 in FIG. 4, the user-required content type information 232 is stored in the database 212 (step 418 in FIG. 4) and associated with the user's registration information record 230 to complete the user information 228.

FIG. 7 shows, in more detail, the content of the user information 228 stored in the database 212 after steps 406 and 418 in FIG. 4 have been performed.

The registration information record 230 for a user contains the user ID 702, password 704, user name 706, address 708 and contact information 710 including an e-mail address and telephone number. The record 230 may also contain a profile of the preferred subject areas 712 indicated by the user during the registration process as described above, and any other demographic information provided by the user.

The user-required content type information 232 comprises a list of content types as selected in step 412 of the process shown in FIG. 4. In the example shown in FIG. 7, the user has selected six content types 720.

Referring back to FIG. 1, after the user has made the content selection at step 104, this information is then used to generate, at step 105, a customised section of the publication, which is in turn used to pick, collate and stack, at step 106, the pre-printed sections.

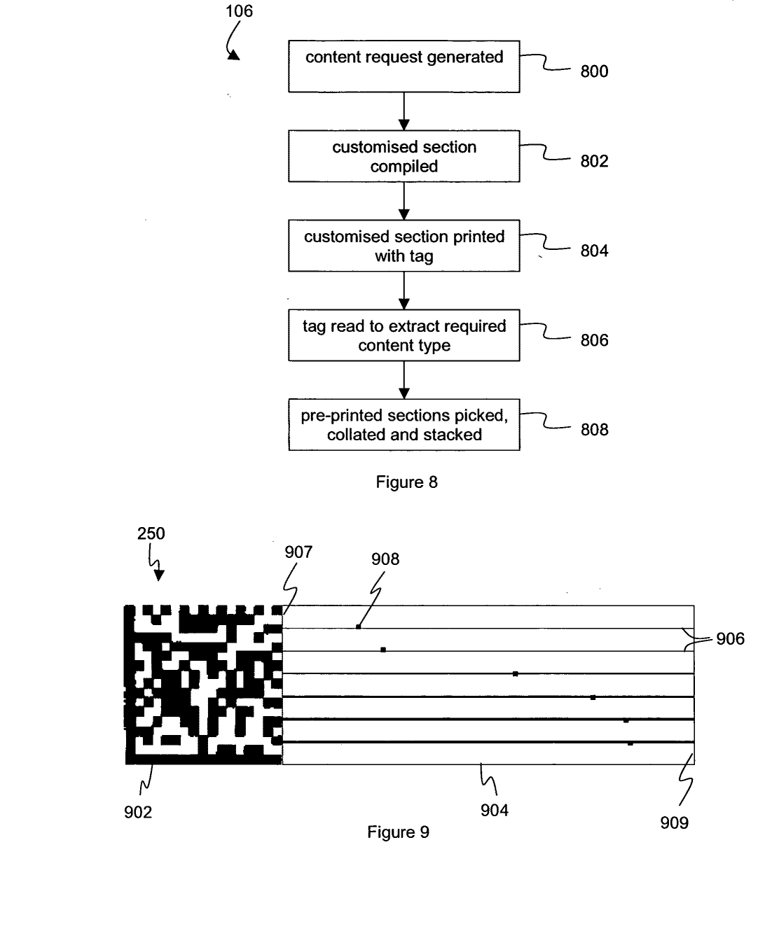

The customised section generation process 105 and picking, collating and stacking process 106 are outlined in FIG. 8. First, information from the database 212 is extracted, at step 800, into a user-defined content request. Specifically, the geographical information received from the user, in the form of the user's name 706 and address 708, and the required content types 720 are extracted from the database 212 to form a received user-defined content request 213.

A customised section 248 of the publication document is compiled at step 802. The content of the customised section is determined by the content request.

A customised section 248 of the publication document is produced at step 804. The customised section 248 includes a machine-readable tag 250 which contains the user-defined content request 213.

The tag is read, at step 806, to extract the user-required content type information. Then, the appropriate pre-printed sections 264, corresponding to each of the required content types 720, are picked, collated and stacked at step 808.

Each of these steps will now be described in more detail, referring again to FIG. 3.

The request generator 224 of the server 210 extracts at step 802 in FIG. 8, the user's name 706 and address 708 and the required content types 720 from the user information 228 stored in the database 212 (see also FIG. 7). This electronic information together forms the user-defined content request 213, which is transferred electronically to the production assembly apparatus 214.

The production assembly apparatus 214 includes a customised section generator 240 having a processor 242. The processor receives the content request, and uses the required content type information 720 to compile page images for a customised section 248 of the publication document.

The processor 242 is connected to a content database 244 which contains editorial and advertising content. Each content item in the content database 244 is associated with one or more content types. The processor 242 is arranged to select a range of content items from the content database 244 based on the required content type information 720 in the database, and to compile these content items into page images (namely digital representations of document pages in a format readable by a digital printing press) for the customised section 248.

In this way, editorial and advertising content relevant to the user's interests is included in the customised section. The processor 244 can also generate a table of contents based on the required content type information 720 for inclusion in the customised section.

The processor 244 also converts the received content request into a form suitable for including in a machine-readable, printable tag. The tag is added to a page image of the customised section.

The page images are transferred to a raster image processor (RIP) of a digital printing press 246, which processes the page images and prints a customised section 248, including the tag 250 (step 804 in FIG. 8). As the size of the customised section 248 is small in proportion to the publication document, the cost associated with bespoke printing is also relatively small.

An example of an optically-readable, printed tag 250 is shown in FIG. 9. The tag includes a first portion 902 which contains the geographical information of the user (i.e. the user's name 706 and address 708) encoded in a two-dimensional barcode format.

In a second portion 904 of the tag 250, the required content type information is encoded using an array of parallel tracks 906. The tracks 906 are lines running from a left-hand reference line 907 to a right-hand reference line 909 and having increasing thicknesses moving from the top of the tag 250 to the bottom of the tag 250, in the orientation shown in FIG. 9. A square block 908 is superimposed on each track 906.

Each track 906 represents a single pre-printed section of the publication document. Thus, the tag shown in FIG. 9 is suitable for a publication document that is to be made up of six pre-printed sections. The thickness of each track 906 is indicative of the section to which that track relates. For example, the thinnest track 906, uppermost in FIG. 9, relates to the first section of the six, the second-thinnest track 906, second from the top in FIG. 9, relates to the second section of the six, and so on.

The user-required content type of each section is indicated by two aspects of the position of a block 908 relative to the respective track 906 on which the block 908 is superimposed.

The first aspect of the position of the block 908 which indicates the user selection information is the relative horizontal position of the block 908 with respect to the reference lines 907, 909 at the ends of the tracks 906.

So, in the example of FIG. 9, where 100 possible content types are available for selection by the user, a user selection of the first content type of the 100 types is indicated by the block 908 being positioned at the left-most edge of the track 906, adjacent to the left-hand reference line 907.

A user selection of the one hundredth content type would be indicated by the block 908 being positioned at the right-most edge of the track 906, adjacent to the right-hand reference line 909.

The remaining content types are allocated to intermediate relative positions of the block 908 and the reference lines 907, 909. For example, a user selection of the fiftieth content type would be indicated by the block 908 being positioned on the track 906 midway between the reference lines 907, 909.

The second aspect of the position of the block 908 which indicates the user selection information is the relative vertical position of the block 908 with respect to a centre line of the respective tracks 906.

A user selection of the first content type of the 100 types is therefore indicated by the centre line of the track 906 intersecting the top edge of the block 908. A user selection of the one hundredth content type would be indicated by the centre line of the track 906 intersecting the bottom edge of the block 908. The remaining content types are allocated to intermediate relative positions of the block 908 and the track 906. For example, a user selection of the fiftieth content type would be indicated by the centre line of the track 906 intersecting the centre of the block 908.

Because the user-required content type information is stored using two independent aspects of the tag 250, namely the relative horizontal and vertical positions of the block 908 with respect to the tracks 906, the tag 250 shown in FIG. 9 can be read with high speed and accuracy by an optical reader.

For example, by using both the relative horizontal and vertical positions of the block to determine, independently, the user-required content type information for each section, a cross-check can be performed to verify that the information obtained using the relative horizontal position is the same as that obtained using the relative vertical position. If the information obtained by the two positional aspects is not the same, a reading error is noted and the tag 250 can be re-read.

Furthermore, if reading of the tag 250 takes place while the tag 250 is moving relative to an optical tag reader, for example as may be caused by jitter or reading during conveying of the section to which the tag 250 is applied, a mis-registration or distortion effect may occur in the images captured by the reader. Such distortion could produce errors in the information obtained from the tag if only a single positional aspect of the blocks 908 were used to convey the information.

For example, if the tag 250 moves relative to the reader in a direction parallel to the tracks 906, the relative horizontal position of the blocks 908 with respect to the reference lines 907, 909 may be distorted. However, using the tag 250 of FIG. 9, the information can still be accurately obtained by using the relative vertical position of the blocks 908.

Similarly, if the tag 250 moves relative to the reader in a direction perpendicular to the tracks 906, the relative vertical position of the blocks 908 with respect to the tracks 906 may be distorted. In this case, the information can still be accurately obtained by using the relative horizontal position of the blocks 908 with respect to the reference lines 907, 909.

Even if the tag 250 moves relative to the reader at an angle which is neither parallel to nor perpendicular to the tracks 906, the relative vertical and horizontal position of each block 908 with respect to the tracks 906 can be measured and the two measurements correlated together, for example using processing techniques known in the art, to remove the effect of any distortion caused by the relative movement, thus corroborating the information obtained. The user-required content type information can still therefore be reliably obtained from the tag 250.

Used in this way, the second portion 904 of the tag 250 of FIG. 9 provides a new and improved way of storing data in optically-readable form on a physical medium, which allows accurate retrieval of the data when the medium moves at high speed and in any angular rotation relative to an optical reader.

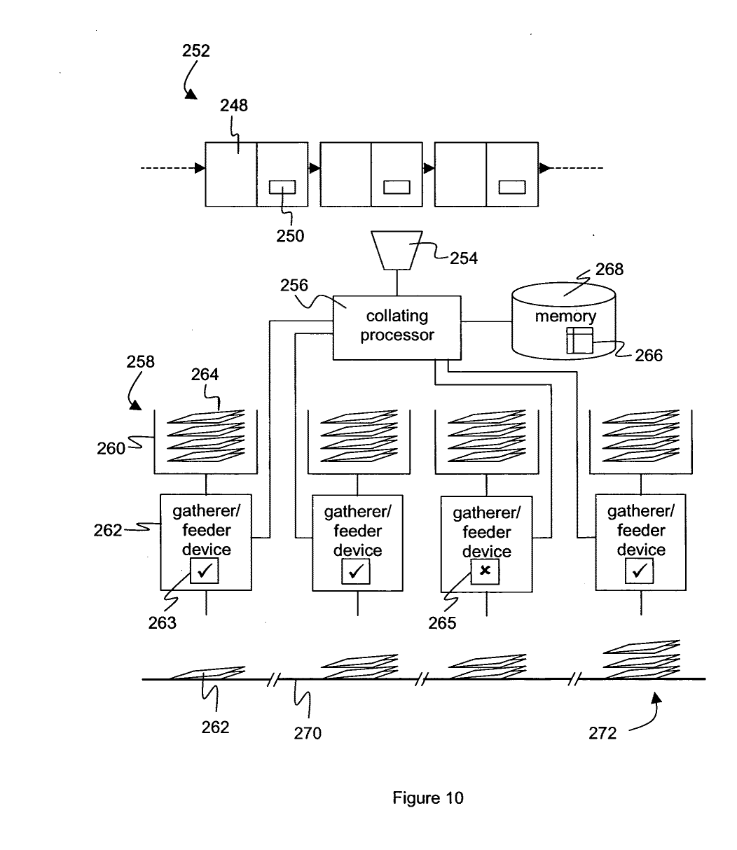

A number of printed customised sections 248 are then transferred to a collating machine 252, shown schematically in FIG. 10. The customised sections 248 are fed, in turn, past a tag reader 254. The tag reader 254 is arranged to read information from the tag 250 on the customised section 248 (step 806 in FIG. 8).

A collating processor 256 receives the tag information from the tag reader 254, and processes the information to extract the user-required content type information (720 in FIG. 7).

The collating machine 252 includes an array of gatherer/feeder stations 258. Each gatherer/feeder station comprises a distribution hopper 260 and a gatherer/feeder device 262. In use, the distribution hopper 260 of each gatherer/feeder station 258 is filled with a stack of ready-folded, pre-printed sections 264. All of the pre-printed sections 264 in each single hopper 260 are identical and correspond to a single content type, while the pre-printed sections 264 in adjacent hoppers 260 are different and correspond to different content types.

The number of filled gatherer/feeder stations 258 in the array corresponds to the number of content types presented to the user for selection in step 410 of FIG. 4. In this way, the array of gatherer/feeder stations 258 corresponds directly to the list 514 of content types presented to the user via the selection page 512 (see FIG. 5). The correspondence between the gatherer/feeder stations 258 and the list 514 of available content types is stored as a correspondence table 266 in a memory 268 of the collating processor 256.

The distribution hoppers 260 of the gatherer/feeder stations 258 together form a physical store for the pre-printed sections 264, which can be supplied to the collating machine 252 from one or more off-site sources such as magazine publishing houses. Because a large number of identical pre-printed sections 264 are used to supply each gatherer/feeder station 258, the pre-printed sections 264 can be produced by high-volume printing processes such as offset lithography, gravure printing or flexography, and the cost of producing the pre-printed sections is low. In this way, the high costs of bespoke printing can be avoided.

The collating processor 256 uses the correspondence table 266 to generate a ‘yes’ or ‘no’ value for each of the gatherer/feeder devices 262. If a gatherer/feeder station 258 contains pre-printed sections of a content type contained in the user-required content type information extracted from the tag, a ‘yes’ value 263 is generated for the respective gatherer/feeder device 262. If a gatherer/feeder station 258 contains pre-printed sections of a content type that is not contained in the user-required content type information extracted from the tag, a ‘no’ value 265 is generated for the respective gatherer/feeder device 262.

The ‘yes’ or ‘no’ values are sent as electronic signals to the appropriate gatherer/feeder devices 262. The gatherer/feeder devices 262 are arranged such that, when a gatherer/feeder device 262 receives a ‘yes’ signal from the collating processor 256, the device 262 gathers a pre-printed section 264 from the distribution hopper 260 and feeds it to a collation train 270. If a gatherer/feeder device 262 receives a ‘no’ signal from the collating processor 256, a pre-printed section 264 is not fed to the collation train 270 from that gatherer/feeder station 258.

By way of example, four gatherer/feeder stations 258 are shown in FIG. 10. However, in practice there are typically many more stations (the same number as the number of content types presented to the user). The first gatherer/feeder station 258 is leftmost in FIG. 10, and the fourth is rightmost. The user has selected three content types corresponding to the pre-printed sections 264 provided in the first, second and fourth gatherer/feeder stations 258.

After reading the tag 250 and processing the required content type information, the collating processor 256 sends a ‘yes’ signal to the first, second and fourth gatherer/feeder devices 262, as indicated by the ticks 263 in FIG. 10, and a ‘no’ signal to the third gatherer/feeder device 262, as indicated by a cross 265.

The first gatherer/feeder station 258 feeds a first pre-printed section 264 onto the collation train 270. The collation train 270 transports the first pre-printed section to the second gatherer/feeder station 258, which feeds another pre-printed section 264 onto the collation train 270, on top of the first pre-printed section 264. The collation train 270 transports both pre-printed sections to the third gatherer/feeder station 258, where no further section is added, and then to the fourth gatherer/feeder station 258 where a further pre-printed section 264 is fed onto the pre-printed sections 264 already on the collation train 270.

In this way, a compilation or stack 272 of pre-printed sections 264, with content types corresponding to the content types 720 required by the user, is generated by the collating machine 252. The customised section 248, and in particular the tag 250, is thus used to control the operation of compiling the multiple section publication document.

The information from the tag 250 is read at the start of the operating cycle of the collating machine 252, so as not to slow down the collating operation.

The stack 272 of pre-printed sections 264 is then checked to ensure that the correct pre-printed sections 264 have been collated into the stack 272 (step 108 in FIG. 1).

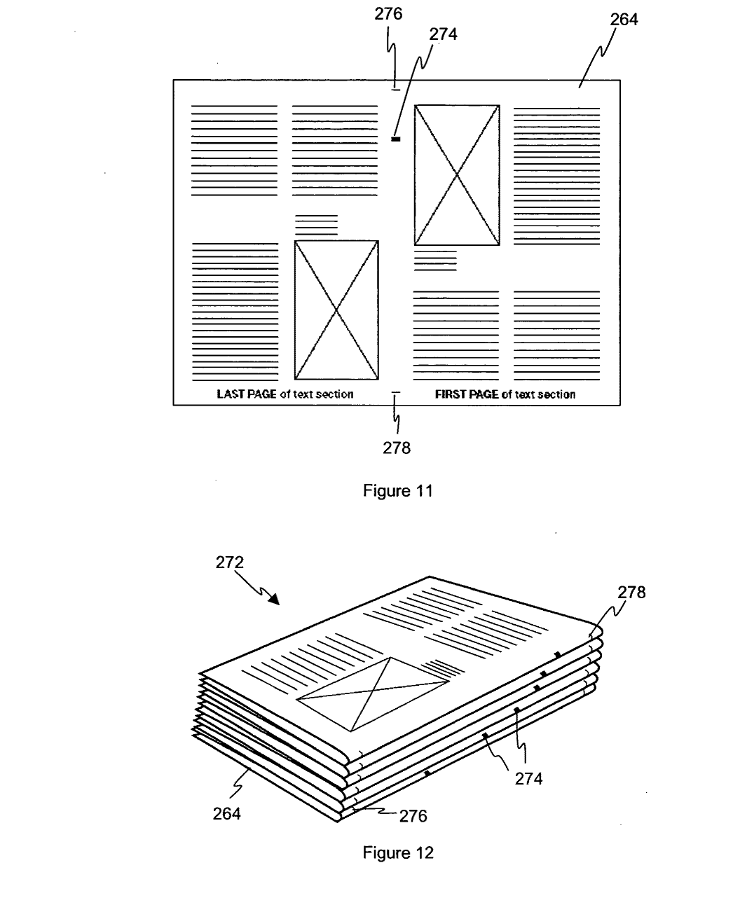

As shown in FIG. 11, each of the pre-printed sections 264 includes a machine-readable pre-printed content type spine mark 274. The spine mark 274 lies between a top reference mark 276 and a bottom reference mark 278. The position of the spine mark 274, relative to the reference marks 276, 278, is indicative of the content type of the pre-printed section 264.

For example, if there are 100 available content types, the space between the reference marks 276, 278 is divided into 100 segments, each segment corresponding to one of the 100 content types. The spine mark 274 is printed in the appropriate segment to indicate the content type of the pre-printed section 264. Optionally, the spine mark is printed along with the rest of the pre-printed section 264.

The spine mark 274 is positioned so that, when a pre-printed section 264 is folded ready to be loaded into the distribution hopper 260 of a gatherer/feeder station 258 of the collating machine 252, the spine mark 274 is visible on the outside spine of the section 264.

As shown in FIG. 12, once the stack 272 of pre-printed sections 264 has been generated in accordance with the process of FIG. 8, the spine marks 274 and reference marks 276, 278 of each section 264 are visible on the spines of the stacked sections 264.

In this way, the spine marks 274 collectively form a machine-readable indication of the content types present in the stack 272. Taken together, the spine marks 274 act as a fingerprint unique to a stack 272 having a certain composition and order of pre-printed sections.

The spine mark 274 is thicker than the reference marks 276, 278, to allow the spine mark 274 to be readily distinguished from the reference marks 276, 278 by an optical reader.

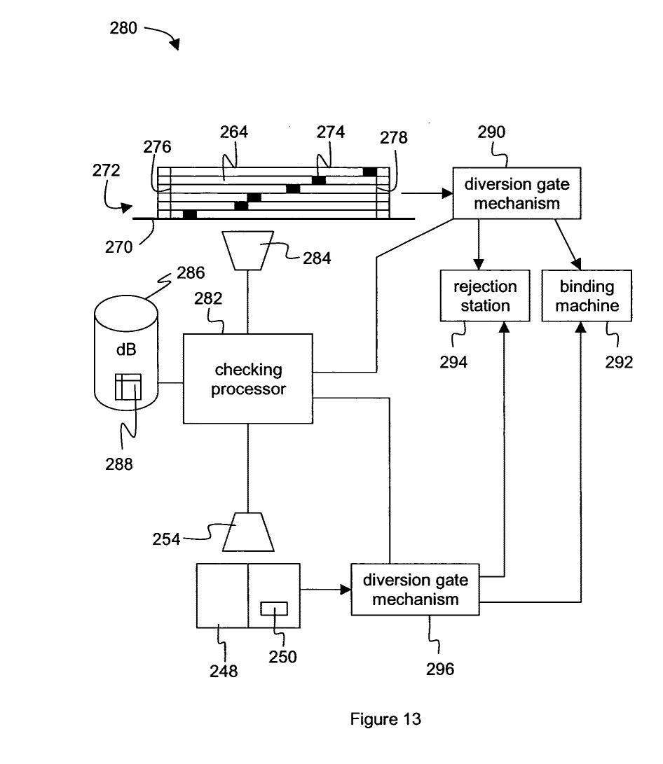

The checking process at step 108 in FIG. 1 is performed by a checking apparatus 280, shown in more detail in FIG. 13. The checking apparatus 280 comprises a checking processor 282, which receives data from a spine mark reader 284. The spine mark reader 284 is arranged to read the spine marks 274 from each of the pre-printed sections 264 in a stack 272 as the stack 272 passes by the spine mark reader 284 on the collation train.

The checking processor 282 includes a memory 286 which stores, in a correspondence table 288, the correspondence between the position of a spine mark 274 relative to the reference marks 276, 278 and the content type represented by a spine mark 274 in that position. Using the correspondence table 288, the checking processor 282 can determine the actual content types present in the stack 272.

The customised sections 248, generated in step 804 of the process of FIG. 8, are also fed into the checking apparatus 280 so that the customised section 248 corresponding to the stack 272 under examination is available to the checking apparatus 280. The checking apparatus 280 includes a tag reader 254 arranged to read information from the tag 250 on the customised section 248.

In operation, the checking processor 282 reads the tag 250 from the customised section 248 and extracts the user-required content type information 720. The checking processor 282 then compares this user-required content type information 720 with the actual content types present in the stack 272, as determined by reading the spine marks 274.

If the actual content types present in the stack 272 are found to match the user-required content type information 720, the checking processor 282 provides a signal to a diversion gate mechanism 290 on the collation train 270 which causes the diversion gate mechanism 290 to direct the stack 272 to a binding machine 292.

If, however, the actual content types present in the stack 272 do not match the user-required content type information 720, the checking processor 282 provides a signal to the diversion gate mechanism 290 which causes the diversion gate mechanism 290 to direct the stack 272 to a rejection station 294.

A second diversion gate mechanism 296 is also provided, which receives the same signal as the diversion gate mechanism 290 on the collation train 270. In response to this signal, the second diversion gate mechanism 296 diverts the customised section 248 to the binding machine 292 or to the rejection station 294.

The pre-printed sections 264 of the stacks 272 which are directed to the rejection station 294 are returned to the appropriate gatherer/feeder stations 258. The customised sections 248 which are directed to the rejection station are fed back in to the collating machine 252 for re-collation of the stack 272.

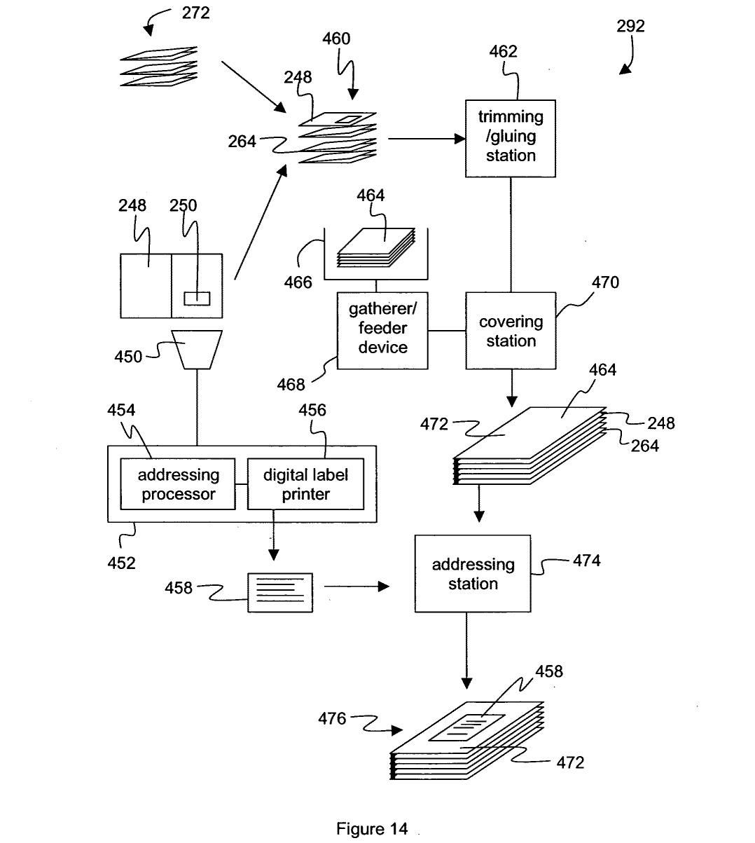

The binding machine 292 is shown in greater detail in FIG. 14. In this embodiment, the binding machine 292 is a free-standing spine-glue binding machine. As described above, the binding machine 292 receives a customised section 248 and corresponding stack 272 from the checking apparatus 280.

The binding machine includes a tag reader 450 which is arranged to read the tag 250 from the incoming customised section 248. The tag reader 450 relays the tag information to an addressing apparatus 452, which includes an addressing processor 454. The addressing processor 454 extracts the geographical information from the tag, in the form of the user's name 706 and address 708. The addressing apparatus 452 also includes a digital label printer 456, which prints the geographical information onto an adhesive label 458.

Meanwhile, the customised section 248 is added to the corresponding stack 272 (step 110 in FIG. 1) to form an unbound publication document 460 comprising a customised section 248 and a plurality of pre-printed sections 264.

The unbound publication document 460 is fed to a trimming and gluing station 462, where the spines of the customised and pre-printed sections 248, 264 are trimmed so as to separate the individual pages of the sections 248, 264. Glue is then applied to the trimmed edge or spine of the unbound publication document 460.

A supply of jackets or covers 464 for the publication document are provided in a distribution hopper 466 connected to a gatherer/feeder device 468. The covers 464 are fed from the hopper 466 by the gatherer/feeder device 468 to a covering station 470, which also receives the trimmed, glued unbound publication documents 460 from the trimming and gluing station 462. In the covering station 470, a cover is adhered to the glued spine of the unbound publication document 460 to complete the binding and finishing of the publication document (step 112 in FIG. 1). Conveniently, the covering station 470 is integrated with the trimming and gluing station 462.

After the cover 464 has been affixed, the publication document 460 may be trimmed to size using a three-knife trimmer (not shown), as is known in the art.

The finished publication document 472 is then transported to an addressing station 474, in which the publication document 472 is wrapped in a protective bag (not shown). The publication document 472 is addressed by affixing the address label 458 to the publication document 472.

Referring back to FIGS. 1 and 2, the finished, addressed publication document 476 is passed to a postal service 216 for delivery to the user (step 114 in FIG. 1).

The finished publication document 476 therefore comprises a multiple-section publication document, the majority of which comprises pre-printed sections that can be produced at low cost and high quality by high-volume printing processes such as offset lithography. Only a minor part of the publication document, namely the customised section, is printed individually for each copy of the publication document. Nevertheless, by virtue of the content type selection process of the present invention, the entire multiple-section publication document is personalised or customised for the individual user who ordered the magazine without the cost and impracticalities of printing an entire individual publication document for each user.

It is anticipated that each of the pre-printed sections will be a relatively short excerpt or sample of a volume-produced publication document available for general sale or subscription, such as a magazine title. Because the invention uses pre-printed sections for compilation into the multiple-section publication document, these excerpts or samples can be produced by the magazine publishers themselves, or under licence, at very little cost using existing high-volume print facilities or services. In this way, the present invention provides a cost-effective method of showcasing magazines and other publication documents.

Each of the pre-printed sections may be formatted into a common style template, including standard fonts and sizes, and standard leading and tracking for headings, sub-headings, body text, barkers and picture captions to give the finished multiple-section publication document a unified look.

The content types presented to the user during the ordering process (step 410 in FIG. 4) could be in the form of magazine titles, in which case the user directly selects the source of the content in each pre-printed section ordered. For example, the content types presented could include “Vogue”, “Scientific American”, “National Geographic”, and so on.

The content types presented to the user could instead be in the form content categories, a content category in the magazine example being a relatively broad range of subject areas in which several magazine titles are commercially available. The magazine title currently available which corresponds to a subject area could also be presented to the user, for example when the user clicks to request further information. In this case, the user indirectly selects the source of the content in each pre-printed section ordered. For example, the presented content types could include “golf” and “motors”, and the magazine titles corresponding to those content types could be “Golf World” and “Autocar” respectively.

In another variant, the content types presented to the user are in the form of content categories, but in this case the user does not select the source of the content. Instead, one or more pre-printed sections are allocated into each content categories, so that the sources of the pre-printed sections received by the user in the publication document are not selected by the user.

Indeed, two or more pre-printed sections from different sources could be allocated into each content category, so that the user receives a pre-printed section from a source determined by an operator of the process or automatically by the collating processor. In this way, the invention can be used to provide publication documents which show-case content sources that might not otherwise be selected by the user. For example, the content types presented to the user could include the content category “fashion”, and the available pre-printed sections for that category could include a section from a first source, such as “Vogue”, and a section from a second source, such as “Elle”. In this case, the collating processor is arranged to select which of the available pre-printed sections is to be included in the publication.

The list of content types presented to the user (for example as shown at 514 in FIG. 5c) may take any suitable form, depending on the nature of the content types to be presented. For example, the content types could be presented in the form of a sub-menu system.

It will be appreciated that many other variations and modifications of the exemplary embodiment described above could be made without departure from the spirit and scope of the present invention as set forth in the appended claims.

For example, two or more of the components of the production assembly apparatus could be integrated into a single machine. In particular, in one variant of the invention, the collating machine, checking apparatus and binding machine are integrated into a single machine. In such a case, the customised sections produced by the customised section generator would be fed into the integrated collating, checking and binding machine, and the multiple-section publication documents would be generated automatically without further intervention from an operator.

As will be readily appreciated by those skilled in the art, the ordering process described with reference to FIGS. 4 to 6 can be modified and adapted to suit the commercial application of the invention. As already noted, the payment step may be omitted. In a further example, it may be desirable to present users with a list of content types at step 410 in FIG. 4 which varies according to the availability of pre-printed sections corresponding to the content types. Alternatively, the list of content types may always be the same, in which case additional steps may be included to verify whether the selected content types are available and, if not, to direct the user to make an alternative choice.

The machine-readable tag may be of any suitable form. For instance the tag could be in the form of a smart label, 1- or 2-dimensional barcode, matrix code, radio frequency (RF) tag, magnetic strip, or similar information carrier. Conceivably, the tag could include printed text, so that the tag is readable by a human operator. The geographical information and user-required content type information may be provided in a single tag or in two separate tags, possibly of different kinds.

When the tag is a printable form, the tag may be printed as an integral part of the customised section. However, the tag may also be printed on a label which is then affixed to the customised section. When the tag is in a non-printable form, such as an RF tag, the tag can likewise be created in label form and affixed to the customised section. In this regard, a cover or other section of the magazine having a tag in the form of an attached label comprises a customised section.

The tag need not contain all of the user information and required content type information. Instead, the tag may include a unique reference number or other identifier associated with the user and/or the user's order in a database. In this case, part or all of the information required in the collating and/or the addressing processes can be obtained by accessing the database, via a secure network service or by other means, and looking up the required information using the unique identifier obtained from the tag.

Advantageously, the customised section is an internal section of the publication document. This arrangement means that the production cost of the customised section is relatively low.

The customised section could instead be a customised cover for the publication document. In that case, the tag may be optically readable after the cover has been attached to the pre-printed sections, so that, in the addressing step, the geographical information can be read from the tag after finishing and binding of the publication document. Alternatively, the user's postal address could be included on the customised cover in a form visible after the publication has been packaged for delivery, so that no separate addressing step is required. In this case, the addressing processor (454 in FIG. 14) would be incorporated with the processor 242 of the customised section generator 240 of FIG. 3.

Various other forms of addressing the publication can be envisaged. For example, the user's postal address could be included on a customised section comprising an internal section of the publication document, and a window could be provided in a (non-customised) cover so as to render the postal address visible when the completed publication has been packaged for delivery. Again, in this embodiment, no separate printed address label or addressing step is required, and the addressing processor (454 in FIG. 14) would be incorporated with the processor 242 of the customised section generator 240 of FIG. 3.

In another embodiment, in which the publication is put into a protective bag before delivery, the addressing apparatus is arranged to print the user's postal address onto the bag using ink-jet or similar technology instead of producing printed address labels. In this case, the tag of the customised section may be read by the addressing apparatus after the publication has been put into the bag or, alternatively, the tag may be read at an earlier stage in the finishing process.

In a further embodiment, in which the publication is put into a protective bag before delivery, the addressing apparatus is arranged to print the user's postal address onto an address carrier sheet instead of an address label. The address carrier sheet typically includes postal pre-payment information, text and imagery along with the user's postal address. The address carrier is placed inside the bag, between the cover and the bag so that the address is visible from outside the bag. Conceivably, such an address carrier sheet could include other customised content.

It will be appreciated that, when the customised section comprises a cover, the customised section will be added to the stack after the spines of the pre-printed sections have been trimmed and glue applied thereto.

When the customised section is an internal section of the publication document, the customised section may be added to the collated stack of pre-printed sections before the checking step takes place. In such an arrangement, in the checking process, the tag may be read from the customised section while the customised section forms part of the stack.

In general terms, the point in the publication document generation process at which the customised section is added to the stack will depend on the nature of the customised section and the nature of the publication document. It is conceivable, for example, that the customised section could be incorporated into an intermediate position in the stack during the collation process by adding the customised section to the collation train. This would result in the customised section appearing in between pre-printed sections, which may be appropriate for a brochure or catalogue-style publication. In such a case, if it were necessary to read the tag subsequent to the insertion of the customised section in the stack, an optically-readable tag could be provided on an oversized portion of the customised section. Alternatively, a non-optical tag such as an RF tag could be used.

An alternative form of binding may be used instead of spine-glue binding. For example, the publication document may be stapled, thermally bound, spiral bound and so on.

Although a complete system for ordering, compiling, checking, binding and addressing a multiple-section publication document has been described, it will be recognised that each component of the system could be used independently from the other components.

In particular, the checking process described with reference to FIG. 13 could be used to determine the actual composition of any compilation of sections having suitable spine marks. For example, the checking process could be used to check a manually-collated compilation of sections.

Instead of a spine mark, a different machine-readable indicia could be used in the checking process. For example, a magnetic strip containing encoded content type information could be used as the indicia.

In many applications of the invention, the available pre-printed sections are updated on a regular basis. For example, for magazine-style publication documents, each pre-printed section could be updated on a monthly basis, corresponding to the monthly publication cycle of a commercially-available conventional magazine on which the pre-printed section is based.

Consequently, when an existing user returns to make place a second or subsequent order for a publication document, it is preferred if the ordering process prevents the user from making a content type selection that would result in the user receiving the same pre-printed section twice. To this end, the web server may be arranged to identify content types previously ordered by a logged-in user, and to present to the user only those previously-ordered content types which have been updated since the user's last order.

While the present invention is particularly suited to the generation of magazine-type publication documents, the invention can also be used to generate different types of publication document, including journals, books, catalogues, directories, brochures and so on.

It will also be appreciated that, as users place orders for publication documents in accordance with the process outlined in FIG. 4, a substantial amount of useful information is obtained from the users and stored in the database of the server. Accordingly, an embodiment of another aspect of the present invention involves using the obtained information for understanding the reading habits of users.

Unlike previously known systems for obtaining and compiling such information, such as surveys or store loyalty cards, the data collected in the context of the present invention is based on selections made by and, in some cases, paid for by an individual user, for compilation into a single publication document. Thus it is likely that the selections made will be an accurate reflection of an individual's own reading tastes and consequently the information will be accurate and valuable.

For example, the required content type information 720 (in FIG. 7) and subject area information 712 (if provided) can be statistically analysed, along with other optionally provided demographic information such as age group, household income, sex and so on. The user's geographical area can also be determined from their postal address and included in the analysis. Additional information can be recorded about a user's ordering habits, such as the frequency of ordering and typical time and date of purchase. This information could be collated and a report compiled for use by content providers, such as publishers, in understanding the reading habits of users. Such information is also useful in understanding who is using the bespoke publication document service of the invention.

Furthermore, provided the necessary data protection permissions are obtained from the user at the time of registration or ordering, comprehensive personal data on users including their names, addresses and other contact information could be provided to third parties for marketing purposes. Again, this information could be linked with the user's content type preferences to provide useful and accurate data. The data could be used to select appropriate advertisements, offers, competitions, incentives and so on for delivery to a user based on their known content type preferences.

Another useful set of information that is readily obtained from the processes in the present invention, which has not previously been available, is the co-reading habits of the users. In other words, because the user makes an order for a single, unitary publication, it is most likely that an individual user will read all of the pre-printed sections included in the publication document.

By way of example, when the available pre-printed sections comprise excerpts or samples of commercially available magazine titles, a report could be generated detailing how many users selected a given title and giving a statistical breakdown of which other titles were selected, and most likely read, together with that title.

It may transpire, for example, that a surprisingly high number of users who select content types relating to cars also tend to select content types relating to travel, from which it could be concluded that readers of car magazines are also interested in travel. Thus, in this example, a publisher might decide to include features and advertisements relating to travel in a car magazine based on the new information provided by the invention.

The co-reading habit information would give content providers, such as publishers, a powerful insight into the reading habits of a user which could be commercially exploited. This information would be difficult to gather using prior art methods such as surveys and store loyalty cards, but is readily available in an accurate form from the present invention.

The present invention can also be extended into the field of post-purchase market research. As noted above, the server stores a database of past and current users who have ordered a multiple-section publication document. Those past and current users could be contacted via e-mail or by other means to obtain information relating to their behaviour after reading the ordered publication document. For example, the users could be asked whether they purchased a full copy of a magazine at a newsstand or subscribed to a magazine after reading an excerpt or sample of that magazine in the ordered publication document.

1. A method of producing a multiple-section publication document in a high-volume industrial process, the method comprising:
generating a customised section of the multiple-section publication document, the customised section including user-required content type information and geographical information, obtained from a received user-specified content request; and
using the customised section to control an operation of compiling the multiple-section publication document, wherein the using step includes:
picking, from a store of pre-printed sections, a user-defined compilation of pre-printed sections having content types corresponding to the user-required content type information;
binding the compilation of pre-printed sections and the customised section into a unitary publication document; and
applying a delivery address to the publication document using the geographical information.

2. A method according to claim 1, wherein each pre-printed section comprises a machine-readable identifier for the content type of the pre-printed section, and the using step further comprises:
reading the identifier of each pre-printed section in the compilation of pre-printed sections to obtain an actual content profile of the compilation;
comparing the actual content profile with the user-required content type information from the customised section;
and, if the comparing step indicates that actual content profile differs from the user-required content type information, rejecting the compilation of pre-printed sections.

3. A method according to claim 2, wherein the identifier of each pre-printed section provides a non-overlapping part of a composite compilation identifier, the reading step comprises reading the composite compilation identifier, and the method further comprises:
decomposing the read composite compilation identifier into each of the individual pre-printed section identifiers.

4. A method according to claim 3, wherein a relative positioning of each of the pre-printed identifiers in relation to a reference indicator, indicates a value of the identifier.

5. A method according to claim 4, wherein the compilation is a stack of folded pre-printed sections of the publication document, and the pre-printed identifiers each comprise marks on a spine portion of each pre-printed section.

6. A method according to claim 5, wherein the reading step comprises determining, using an electronic sensor, the relative position of a mark with respect to a reference indicator provided on the spine portion.

7. A method according to claim 3, wherein a plurality of versions of the identifier are provided on the pre-printed section and at least one version is readable without distortion when the compilation is moving along a given direction.

8. A method according to claim 3, wherein a plurality of versions of the identifier are provided on the pre-printed section and the reading step comprises reading at least two versions of the same identifier and the method further comprises correlating together the at least two versions of the same identifier to corroborate a read value of that identifier.

9. A method according to claim 1, further comprising:
embedding the user-required content type information in a machine-readable tag; and wherein the using step further comprises reading the tag to extract the user-required content type information.

10. A method according to claim 1, further comprising:
embedding the geographical information in a machine-readable tag; and, wherein the using step further comprises reading the tag to extract the geographical information.

11. A method according to claim 10, comprising embedding the geographical information in a first part of the machine-readable tag, and embedding the user-required content type information in a second part of the machine-readable tag.

12. A method according to claim 8, wherein a relative positioning of each of a plurality of indicia in relation to a reference indicator, indicates a value of the user-required content type information in the tag.

13. A method according to claim 12, wherein a plurality of versions of the indicia are provided on the tag and at least one version is readable without distortion when the tag is moving along a given direction.

14. A method according to claim 12, wherein a plurality of versions of the indicia are provided on the tag and the reading step comprises reading at least two versions of the same indicium and the method further comprises correlating together the at least two versions of the same indicium to corroborate a read value of that indicium.

15. A method according to claim 1, wherein the user-required content type information comprises at least one user-selected content category.

16. A method according to claim 15, further comprising allocating at least one different pre-printed sections to a plurality of user-selectable content categories.

17. A method according to claim 16, further comprising allocating at least two pre-printed sections from different content sources to each user-selectable content category.

18. A method according to claim 1, wherein the user-required content type information comprises at least one user-selected content sources.

19. A method according to claim 1, wherein the generating step comprises generating a customised section comprised of a cover section of the multiple-section publication document.

20. A method according to claim 1, wherein the generating step comprises generating a customised section comprised of an internal section of the multiple-section publication document.

21. A method according to claim 1, wherein the generating step comprises generating a customised section comprised of an index of each of the sections of the multiple-section publication document.

22. A method according to claim 1, comprising selecting at least one content items for inclusion in the customised section.

23. A method according to claim 22, wherein the selecting step comprises selecting at least one content item for inclusion in the customised section based on the user-required content type information.

24. A method according to claim 22, wherein the selecting step comprises selecting at least one content item for inclusion in the customised section based on the geographical information.

25. A method according to claim 1, further comprising creating a content request including the user-required content type-information and the geographical information.

26. A method according to claim 25, wherein the creating step is carried out remotely from the generating and using steps and the method further comprises transmitting the remotely-created content request to a multiple-section publication document production location where the generating and using steps are carried out.

27. A method according to claim 26, wherein the creating step is implemented on a remote user computer and the transmitting step comprises transmitting the request over a wide-area communications network to the multiple-section publication document production location.

28. A method according to claim 1, further comprising storing information relating to a plurality of different users, the stored information including the content requests of a plurality of different users.

29. A method according to claim 28, further comprising:
compiling information relating to the stored content requests to enable analysis regarding the associations between the different user-required content types selected by users; and
providing the compiled information to a content generator for analysis.

30. A method according to claim 29, wherein the compiling step includes correlating the associations between the different user-required content types selected by users and the geographical information.

31. A method according to claim 28, further comprising:
updating the store of pre-printed sections with new versions of the sections over a period of time; and
repeating the generating and using steps to create an updated multiple-section publication document after all the sections corresponding to required content types of a content request being processed have been updated.

32. A method according to claim 1, wherein the generating step comprises generating the customised section using bespoke digital printing techniques and each of the pre-printed sections have been printed using high-volume printing techniques.

33. A system for producing a multiple-section publication document in a high-volume industrial process, the system comprising:
obtaining apparatus for obtaining user-required content type information and geographical information from a user from within a user-specified content request;
a generator for generating a customised section of the multiple-section publication document based on the obtained information;
a store of pre-printed sections;
a collator for collating a user-defined compilation of different pre-printed sections,
a controller for controlling the operation of the collator, the controller being arranged to use information from the customised section to-control the operation of the collator;
a binder for binding the compilation of different pre-printed sections and the customised section into a unitary publication document; and
addressing apparatus for providing a delivery address to the publication document using the geographical information.

34. A system according to claim 33, further comprising checking apparatus for checking the compilation of pre-printed sections.

35. A system for producing a multiple-section publication document in a high-volume industrial process, the system comprising:
a generator for generating a customised section of the multiple-section publication document, the customised section including user-required content type information and geographical information, obtained from a received user-specified content request; and
using apparatus for using the customised section to control an operation of compiling the multiple-section publication document, wherein the using apparatus comprises:
picking apparatus arranged to pick, from a store of pre-printed sections, a user-defined compilation of pre-printed sections having content types corresponding to the user-required content type information;
binding apparatus arranged to binding the compilation of pre-printed sections and the customised section into a unitary publication document; and
addressing apparatus arranged to apply a delivery address to the publication document using the geographical information.

36. An electronic method of checking the contents of a compilation of a plurality of different pre-printed sections of a publication document with a user-specified content type information, wherein each pre-printed section of the compilation is provided with a machine-readable section indicium uniquely identifying the content of the section, and wherein the plurality of machine-readable section indicia comprise a composite indicium, the method comprising:
electronically reading the composite indicium to determine an actual content profile of the compilation;
comparing the content profile with the user-specified content type information; and
if the comparing step indicates that actual content profile differs from the user-required content type information, rejecting the compilation of pre-printed sections.

37. A method according to claim 36, further comprising:
decomposing the read composite indicium into a plurality of identifiers of the compiled sections, and wherein the comparing step comprises:
comparing each of the plurality of identifiers with a correct compilation of identifiers as determined by the user-specified content type information.

38. A method according to claim 37, wherein the comparing step further comprises:
comparing an order of the plurality of identifiers with an expected order of identifiers of a correct compilation as determined by the user-specified content type information.

39. A method according to claim 36, wherein the compilation is a stack of folded sections of a publication document, and the section indicia each comprise marks on a spine portion of each section.

40. A method according to claim 39, wherein the reading step comprises determining, using an electronic sensor, the relative position of a mark with respect to a reference indicator provided on the spine portion.

41. A method according to claim 36, wherein each section indicium provides a non-overlapping part of the composite indicium.

42. A method according to claim 36, wherein a plurality of versions of a section indicium are provided on each pre-printed section and at least one version is readable without distortion when the compilation is moving along a given direction.

43. A method according to claim 36, wherein a plurality of versions of an indicium are provided on each pre-printed section, the reading step comprises reading at least two versions of the same indicium, and the method further comprises correlating together the at least two versions of the same indicium to corroborate a read value of that indicium.

44. An electronic checking apparatus for checking the contents of a compilation of a plurality of different pre-printed sections of a publication document with a user-specified content type information, wherein on each pre-printed section of the compilation, a machine-readable section indicium uniquely identifying the content of the section is provided, and wherein the plurality of machine-readable section indicia comprise a composite indicium, the apparatus comprising:
receiving apparatus for receiving the user-specified content type information;
reading apparatus for electronically reading the composite indicium to determine an actual content profile of the compilation;
comparing apparatus for comparing the content profile with the user-required content type information; and
rejecting apparatus for rejecting the compilation of pre-printed sections if the comparing apparatus indicates that actual content profile differs from the user-required content type information.

45. A machine-readable image for storing an information value, the image comprising an indicium and first and second reference indicators;
wherein a relative positioning of the indicium in a first orientation with respect to the first reference indicator and a relative positioning of the indicium in a second orientation with respect to the second reference indicators each independently represents the information value.

46. An image according to claim 45, wherein the indicium comprises a mark within the image.

47. An image according to claim 45 wherein the first reference indicator comprises a reference line.

48. An image according to claim 47, wherein the first orientation comprises a direction perpendicular to the first reference indicator.

49. An image according to claim 46, wherein the first reference indicator comprises a reference line, the first orientation comprises a direction perpendicular to the first reference indicator and the mark intersects the first reference indicator.

50. An image according to claim 47, wherein the second reference indicator comprises a point within the image and the second orientation comprises a direction parallel to the reference line.

51. An image according to claim 50, wherein the second reference indicator intersects the first reference indicator.

52. An image according to claim 47, wherein a thickness of the reference line indicates a further information value.

53. An image according to claim 45, comprising a plurality of indicia for storing a corresponding plurality of information values.

54. An image according to claim 53, further comprising a plurality of pairs of first and second reference indicators, each pair being associated with one of the plurality of indicia.
